(19) United States
(12) Patent Application Publication
(10) Pub. No.: US 2016/0379235 A1
(43) Pub. Date: Dec. 29, 2016

(54) METHODS AND APPARATUS TO ENABLE DUPLICATION CORRECTION FOR BROADCAST STATION AUDIENCE MEASUREMENT DATA

(71) Applicant: The Nielsen Company (US), LLC, New York, NY (US)

(72) Inventors: Helena Mendrisova, Hoffman Estates, IL (US); Edward Ellis Cohen, New Market, MD (US); Dipti Umesh Shah, Pleasanton, CA (US); Antonia Toupet, Sunnyvale, CA (US); Elisabeth Adams, Glen Allen, VA (US)

(21) Appl. No.: 15/194,211

(22) Filed: Jun. 27, 2016

Related U.S. Application Data
(60) Provisional application No. 62/185,419, filed on Jun. 26, 2015.

(51) Int. Cl. G06Q 30/02

(52) U.S. Cl. CPC G06Q 30/0204

(57) ABSTRACT

Methods, apparatus, systems and articles of manufacture to enable duplication correction for broadcast station audience measurement data are disclosed. An example method includes mapping, by executing an instruction with a processor, listening data to a daypart and a demographic group, the listening data generated based on collected audience measurement data, calculating, by executing an instruction with the processor, a first audience measurement and a second audience measurement from the listening data for a plurality of daypart-demographic group pairings, determining, by executing an instruction with the processor, an unduplication factor for a first daypart-demographic group pairing based on the first audience measurement and the second audience measurement, and applying, by executing an instruction with the processor, the unduplication factor to an audience count associated with a streaming station to determine a cumulative audience measurement for the first daypart-demographic group pairing.

### RELATED APPLICATION

This patent claims the benefit of, and priority from, U.S. Provisional Patent Application No. 62/185,419, filed Jun. 26, 2015, entitled “Methods and Apparatus to Enable Duplication Correction for Digital Audio.” U.S. Provisional Patent Application No. 62/185,419 is hereby incorporated by reference in its entirety.

### FIELD OF THE DISCLOSURE

This disclosure relates generally to audience measurement, and, more particularly, to methods and apparatus to enable duplication correction for broadcast station audience measurement data.

### BACKGROUND

Audience measurement of media (e.g., content and/or advertisements presented by any type of medium, such as television, in theater movies, radio, Internet, etc.) is typically carried out by monitoring media exposure of panelists that are statistically selected to represent particular demographic groups. Audience measurement companies, such as The Nielsen Company (US), LLC, enroll households and persons to participate in measurement panels. By enrolling in these measurement panels, households and persons agree to allow the corresponding audience measurement company to monitor their exposure to information presentations, such as media output via a television, a radio, a computer, etc. Using various statistical methods, the collected media exposure data is processed to determine the size and/or demographic composition of the audience(s) for media of interest. The audience size and/or demographic information is valuable to, for example, advertisers, broadcasters, content providers, manufacturers, retailers, product developers, and/or other entities. For example, audience size and demographic information is a factor in the placement of advertisements, in valuing commercial time slots during a particular program and/or generating ratings for piece(s) of media.

### BRIEF DESCRIPTION OF THE DRAWINGS

FIG. 1 illustrates an example system for audience measurement analysis implemented in accordance with the teachings of this disclosure to enable duplication correction for broadcast station audience measurement data.

FIG. 2 is an example data table that may be used by the example central facility of FIG. 1 to store panelist audio measurement data variables in the example panelist audio measurement data database of FIG. 1.

FIG. 3 is an example data table that may be used by the example central facility of FIG. 1 to assign a daypart to listening data.

FIG. 4 is an example data table that may be used by the example central facility of FIG. 1 to assign a demographic group to listening data.

FIG. 5 is a flowchart representative of example machine-readable instructions that may be executed by the example central facility of FIG. 1 to enable duplication correction for broadcast station audience measurement data.

FIG. 6 is a flowchart representative of example machine-readable instructions that may be executed by the example central facility of FIG. 1 to generate listening data.

FIG. 7 is a flowchart representative of example machine-readable instructions that may be executed by the example central facility of FIG. 1 to calculate digital Cume values and duplicate Cume values for combinations of dayparts, demographic groups and reporting periods.

FIG. 8 is a flowchart representative of example machine-readable instructions that may be executed by the example central facility of FIG. 1 to calculate an unduplication factor for daypart-demographic group pairings.

FIG. 9 is a flowchart representative of example machine-readable instructions that may be executed by the example central facility of FIG. 1 to generate an unduplication factor matrix.

FIG. 10 is a flowchart representative of example machine-readable instructions that may be executed by the example central facility of FIG. 1 to calculate a total Cume for a broadcast station.

FIG. 11 is an example calculation of total Cume that may be performed by the example central facility of FIG. 1.

FIG. 12 is a block diagram of an example processing platform structured to execute the example machine-readable instructions of FIGS. 5-9 and/or 10 to implement the example central facility of FIG. 1.

Wherever possible, the same reference numbers will be used throughout the drawing(s) and accompanying written description to refer to the same or like parts.

### DETAILED DESCRIPTION

Examples disclosed herein facilitate duplication correction for broadcast station audience measurement data. Disclosed examples enable adjusting a total audience count for a broadcast station to account for duplicate listening between over-the-air stations and streaming stations. For example, disclosed examples calculate an unduplication factor to apply to audience counts associated with streaming stations at daypart-demographic levels. The deduplicated streaming station audience count is then added to an over-the-air station count to generate a total audience count for a broadcast station.

Radio stations want to know how many people accessed their audio content (including program content and/or advertisement content). Unique audience counts (e.g., ratings information) may be useful for determining a marketing campaign and/or evaluating the effectiveness of a marketing campaign. For example, an advertiser who wants exposure to their asset (e.g., a product, a service, etc.) to reach a specific audience will place advertisements in media (e.g., audio content) whose audience represents the characteristics of the target market. In some examples, radio stations determine the cost of including an advertisement in their media based on the ratings of the media. For example, a high rating for a radio program represents a large number of audience members who tuned to (or were exposed to) the radio program. In such instances, the larger the audience of a radio program (e.g., a higher rating), the more the radio station can charge for advertisements during the radio program.

Traditionally, audio content was consumed via over-the-air (OTA) radio stations. Audience measurement entities would monitor and measure exposure to audio content presented via the OTA station. The audience measurement entities would then process listening data associated with the OTA station (e.g., perform statistical analysis) and calculate an OTA cumulative audience measurement, or Cume, that represents a unique audience count of people who listened to the corresponding OTA station.

However, methods to consume audio content have evolved and users may now consume audio content via streaming stations that present digital audio content. The streaming station (sometimes referred to as a “digital station”) may be accessed using any Internet-enabled device, such as a mobile device (e.g., a tablet, a smart phone, a portable people meter (PPM) device, etc.), a desktop computer, a smart appliance, etc. Similar to OTA audio content, audience measurement entities monitor and measure exposure to streaming stations and calculate a total digital Cume that represents a unique audience count of people who listened to the corresponding streaming station.

Providers/distributors of OTA stations are provided the OTA Cume and providers/distributors of streaming stations are provided the total digital Cume. In some examples, the respective Cume values are provided at different levels. For example, the OTA Cume may be provided for a plurality of daypart-demographic pairings (e.g., Males 18-24 who listened to an OTA station between Monday 6 AM and Monday 7 PM, etc.). Similarly, total digital Cume may also be provided at different levels (e.g., different daypart-demographic pairings). As used herein, the term “total digital Cume” represents a unique audience count of listeners who consumed a streaming station irrespective of device. For example, the total digital Cume may include a mobile digital Cume representative of an audience count who consumed a streaming station via a mobile device (e.g., a smart phone, a tablet, a portable people meter (PPM), etc.) and a desktop digital Cume representative of an audience count who consumed a streaming station via a desktop computer. As used herein, the total digital Cume has been calibrated and adjusted to remove duplicate entries across the different listening platforms (e.g., mobile device and desktop devices). Example techniques for calculating the total digital Cume for audio content are further disclosed in U.S. patent application Ser. No. 15/194,113, filed on Jun. 27, 2016, entitled “Methods and Apparatus to Correct Attribution Errors and Coverage Bias for Digital Audio Ratings”, which is incorporated herein by reference in its entirety.

However, some providers/distributors of audio content may have an OTA presence and a streaming presence. As used herein, the term “radio station” may refer to an OTA station and/or a streaming station. As used herein, a “broadcast station” is a radio station that has (1) an OTA station and (2) a streaming station that has the same ad-load and content-load as the OTA station. For example, if a user is presented with the same advertisement at the same time, regardless of whether the user is listening to the OTA version of a radio station or the streaming version of the radio station, then the radio station is classified as a broadcast station.

It may be useful for providers/distributors of broadcast stations to know how many unique people are listening to their audio content regardless of device. However, there is a risk of overestimating the total broadcast station Cume because simply adding the OTA Cume for the OTA version and the total digital Cume for the streaming version may include duplicate audience counts. For example, the OTA Cume is credited with an exposure when a user listens to a given station, such as ACME FM, while driving to work and the total digital Cume is credited with another exposure when the same user continues listening to the streaming version of ACME FM while at work, thereby counting the same user twice in the total broadcast station Cume for ACME FM.

Examples disclosed herein use listening data collected from panelists and calculate an unduplication factor (UF). The UF represents a percentage of panelists who listened to both station counterparts of a broadcast station (e.g., within a measurement time interval, such as a given daypart, hour, etc.). In some disclosed examples, the UF is applied to the total digital Cume to calculate an adjusted total digital Cume, which is then combined with the OTA Cume to calculate the total Cume for the broadcast station. In some examples, a particular daypart-demographic pairing may not have an OTA Cume. For example, males age 18-24 may not listen to the OTA version of a news talk station while driving to/from work, but may listen to the streaming version of the news talk station while at work. In such instances, because there is no overlap in audience counts between the OTA Cume (e.g., 0) and the total digital Cume, disclosed examples may use the total digital Cume as the total Cume for the broadcast station. Conversely, some disclosed examples may use the total OTA Cume as the total Cume for the broadcast station if there is no digital Cume during the measurement interval of interest.

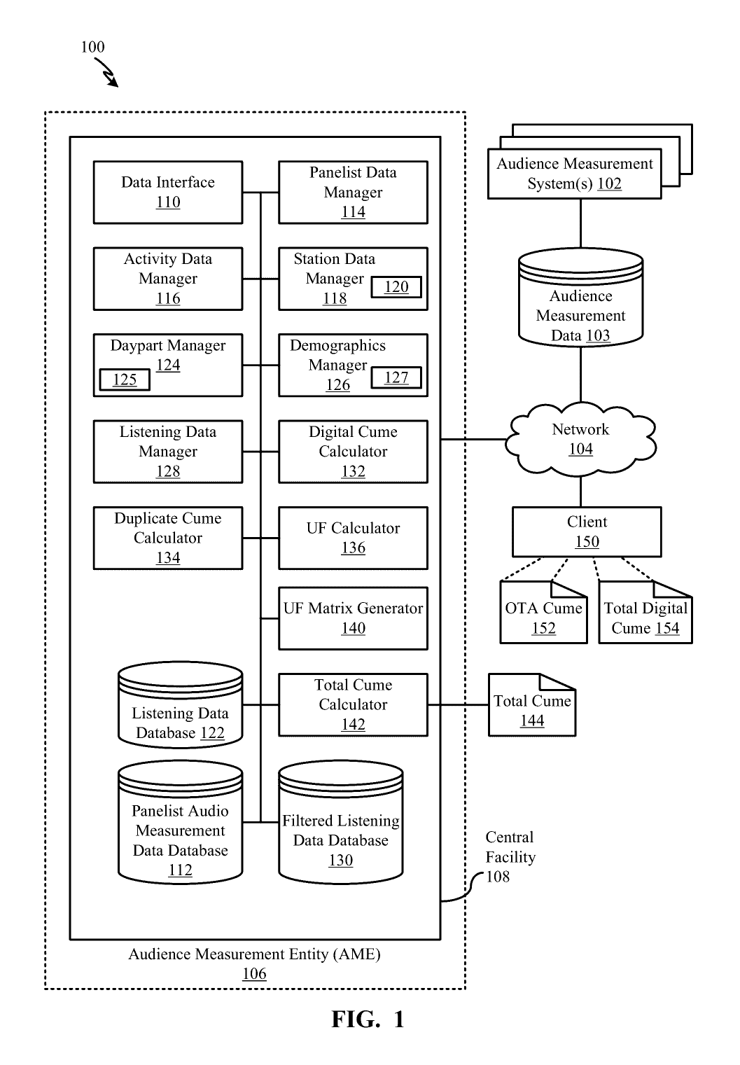

FIG. 1 is a diagram of an example environment in which a system 100 constructed in accordance with the teachings of this disclosure operates to enable duplication correction for broadcast station audience measurement data (e.g., total broadcast station Cume). The example system 100 of FIG. 1 includes one or more example audience measurement system(s) 102, an example client 150 and an example central facility 108 to facilitate duplication correction for broadcast station audience measurement data in accordance with the teachings of this disclosure. In the illustrated example of FIG. 1, the central facility 108 generates reports that include duplication corrected total audience counts (e.g., total Cume) for broadcast stations at the daypart-demographic level.

The example system 100 of FIG. 1 includes the one or more audience measurement system(s) 102 to collect example audience measurement data 103 from users who consume audio content. The example audience measurement system(s) 102 of FIG. 1 collect audience measurement data 103 via, for example, portable people meter (PPM) devices operating in statistically-selected households, set-top boxes and/or other media devices (e.g., such as personal computers, tablet computers, smartphones, etc.) capable of monitoring and returning monitored data for audio content presentations, etc. The audio content may be accessed via traditional OTA radio playback devices that output OTA content and/or via Internet-enabled devices, such as smart phones, tablets, desktop computers, smart appliances, etc., that are capable of streaming digital audio content.

The example audience measurement data 103 of FIG. 1 includes audio exposure data, such as a panelist identifier associated with a panelist, a market identifier (e.g., a market code) associated with a geographic location (e.g., a metro such as Chicago, San Francisco, etc.) of where the audio content was consumed, a station identifier (e.g., call letters code) associated with the radio station, a band identifier (e.g., a band code) indicative of whether the radio station is an OTA station (e.g., FM or AM band code) or a streaming station (e.g., IF or IA band code), a station format identifier (e.g., variety, all sports, news talk, etc.) identifying a station format associated with the radio station, a time stamp identifying a day and/or time when the audio content was consumed, a duration of how many minutes the panelist listened to the audio content, and a reporting period identifier (e.g., week 1, week 2, etc.) associated with when the audio content was consumed. In some examples, the audio exposure data may also include an out-of-market flag to identify whether the exposure to the audio content was in a geographic location outside the market of an OTA station. For example, if the market code for ACME FM maps to Chicago, Ill., audio exposure data that indicates exposure to ACME FM in Indianapolis, Ind. is out-of-market to ACME FM and the corresponding audio exposure data is flagged accordingly.

The example audience measurement data 103 may also include panelist information, such as demographic information (e.g., age, gender, income, etc.) associated with the panelist and a reporting period identifier. In some examples, the panelist information may also include a weekly contribution weight (also referred to as “weekly weight”) associated with the panelist for the corresponding reporting period. In the illustrated example, a weekly contribution weight corresponds to a number of people of similar demographics as the panelist who are represented by the panelist. In some examples, a panelist is assigned the weekly contribution weight when the panelist satisfies an activity threshold during the corresponding week. For example, a panelist may be assigned a weekly contribution weight at the end of a reporting period (e.g., at the end of a week) if the panelist is credited with exposure to audio content at least six of the seven days of the respective week. In some such instances, if the panelist does not satisfy the activity threshold by the end of the reporting period, then the panelist is not assigned a weekly contribution weight.

As used herein, the term “media” includes any type of audio content and/or aural advertisement delivered via a radio station. Thus, media includes radio programming or advertisements, streaming audio, etc.

Example methods, apparatus, and articles of manufacture disclosed herein monitor media presentations at media devices. Such media devices may include, for example, Internet-enabled televisions, personal computers, Internet-enabled mobile handsets (e.g., a smartphone), video game consoles (e.g., Xbox®, PlayStation®), tablet computers (e.g., an iPad®), digital media players (e.g., a Roku® media player, a Slingbox®, etc.), etc. In some examples, media monitoring information is aggregated to determine ownership and/or usage statistics of media devices, relative rankings of usage and/or ownership of media devices, types of uses of media devices (e.g., whether a device is used for browsing the Internet, streaming media from the Internet, etc.), and/or other types of media device information. In examples disclosed herein, monitoring information includes, but is not limited to, media identifying information (e.g., media-identifying metadata, codes, signatures, watermarks, and/or other information that may be used to identify presented media), application usage information (e.g., an identifier of an application, a time and/or duration of use of the application, a rating of the application, etc.), and/or user-identifying information (e.g., demographic information, a user identifier, a panelist identifier, a username, etc.).

In the illustrated example of FIG. 1, the audience measurement system(s) 102 send the audience measurement data 103 to the central facility 108 via an example network 104. The example network 104 of the illustrated example of FIG. 1 is the Internet. However, the example network 104 may be implemented using any suitable wired and/or wireless network(s) including, for example, one or more data buses, one or more Local Area Networks (LANs), one or more wireless LANs, one or more cellular networks, one or more private networks, one or more public networks, etc. The example network 104 enables the central facility 108 to be in communication with the audience measurement system(s) 102. As used herein, the phrase “in communication,” including variances therefore, encompasses direct communication and/or indirect communication through one or more intermediary components and does not require direct physical (e.g., wired) communication and/or constant communication, but rather includes selective communication at periodic or aperiodic intervals, as well as one-time events.

In the illustrated example, the central facility 108 is operated by an audience measurement entity (AME) 106. The example AME 106 of the illustrated example of FIG. 1 is an entity such as The Nielsen Company (US), LLC that monitors and/or reports exposure to media (e.g., audio content) and operates as a neutral third party. That is, in the illustrated example, the audience measurement entity 106 does not provide media (e.g., content and/or advertisements) to end users. This un-involvement with the media production and/or delivery ensures the neutral status of the audience measurement entity 106 and, thus, enhances the trusted nature of the data the AME 106 collects and processes. The reports generated by the audience measurement entity (sometimes referred to as an “audience analytics entity” (AAE)) may identify aspects of media usage, such as the number of people who are listening to a radio station, how long on average a person listens to the radio station, how many times the average person listens to the radio station, etc.

The example AME 106 of FIG. 1 operates the central facility 108 to estimate total Cume for a broadcast station of interest. As used herein, a broadcast station of interest (sometimes referred to herein as a “client”) is a particular broadcast station that is being analyzed (e.g., for a report). For example, a first broadcast station of interest may be ACME radio that has an OTA station (e.g., ACME FM) and a counterpart streaming station (e.g., ACME IF) and a second broadcast station of interest may be XYZ radio that has an OTA station (e.g., XYZ AM) and a counterpart streaming station (e.g., XYZ IA). In the illustrated example of FIG. 1, the central facility 108 generates one or more reports at the request of an example client 150 (e.g., a provider/distributor of a broadcast station, an advertiser, etc.). In the illustrated example, the client 150 provides the AME 106 with an OTA Cume 152 and total digital Cume 154. The example OTA Cume 152 is a unique audience count generated for the OTA station of the broadcast station. The example total digital Cume 154 is a unique audience count generated for the streaming counterpart station of the broadcast station. In the illustrated example, the total digital Cume 154 represents a total unique audience count across all devices used to access the streaming station. Example techniques for calculating the total digital Cume 154 for the streaming station are disclosed in U.S. patent application Ser. No. 15/194,113, filed on Jun. 27, 2016, entitled “Methods and Apparatus to Correct Attribution Errors and Coverage Bias for Digital Audio Ratings.”

In the illustrated example of FIG. 1, the unique audience counts included in the OTA Cume 152 and the total digital Cume 154 are provided at the daypart and demographics level. For example, the OTA Cume 152 may include a first unique audience count for females age 25-34 who listened to the corresponding OTA station between 3 PM and 7 PM on a Saturday, may include a second unique audience count for females age 25-34 who listened to the corresponding OTA station between 7 PM and midnight on a Saturday, may include a third unique audience count for males age 25-34 who listened to the corresponding OTA station between 3 PM and 7 PM on a Saturday, may include a fourth unique audience count for males age 25-34 who listened to the corresponding OTA station between 7 PM and midnight on a Saturday, etc. Although the above examples operate based on the client 150 providing the OTA Cume 152 and the total digital Cume 154, in other examples, the AME 106 may calculate the respective Cumes 152, 154 based on, for example, the audience measurement data 103 collected by the example audience measurement system(s) 102.

The central facility 108 of the illustrated example includes a server and/or database that collects and/or receives audience measurement data related to radio stations and calculates a duplication corrected total Cume (e.g., a unique audience count) 144 for broadcast stations of interest. In some examples, the central facility 108 is implemented using multiple devices and/or the audience measurement system(s) 102 is (are) implemented using multiple devices. For example, the central facility 108 and/or the audience measurement system(s) 102 may include disk arrays and/or multiple workstations (e.g., desktop computers, workstation servers, laptops, etc.) in communication with one another. In the illustrated example, the central facility 108 is in communication with the audience measurement system(s) 102 via one or more wired and/or wireless networks represented by the network 104.

The example central facility 108 of the illustrated example of FIG. 1 processes the audience measurement data 103 returned by the audience measurement system(s) 102 to calculate unduplication factors for respective daypart-demographic group pairings. For example, the central facility 108 may process the audience measurement data 103 to calculate an unduplication factor (UF) that represents an overlap in audience counts for the counterpart stations of a broadcast station. The example central facility 108 may then apply the unduplication factor to the total digital Cume 154 reported for the streaming counterpart of the broadcast station of interest to calculate an adjusted total digital Cume. The adjusted total digital Cume is then added to the OTA Cume 152 reported for the OTA counterpart of the broadcast station of interest to calculate the total Cume 144 for the broadcast station of interest.

In the illustrated example of FIG. 1, the central facility 108 includes an example data interface 110, an example panelist audio measurement data database 112, an example panelist data manager 114, an example activity data manager 116, an example station data manager 118, an example listening data database 122, an example daypart manager 124, an example demographics manager 126, an example listening data manager 128, an example filtered listening data database 130, an example digital Cume calculator 132, an example duplicate Cume calculator 134, an example UF calculator 136, an example UF matrix generator 140 and an example total Cume calculator 142.

In the illustrated example of FIG. 1, the example central facility 108 includes the example data interface 110 to provide an interface between the network 104 and the central facility 108. For example, the data interface 110 may be a wired network interface, a wireless network interface, a Bluetooth® network interface, etc., and may include the associated software and/or libraries needed to facilitate communication between the network 104 and the central facility 108. In the illustrated example of FIG. 1, the data interface 110 receives the audience measurement data 103 returned by the example audience measurement system(s) 102 of FIG. 1. The example data interface 110 records the audience measurement data 103 in the example panelist audio measurement data database 112. The example data interface 110 of FIG. 1 also receives the request to generate one or more reports by the client 150.

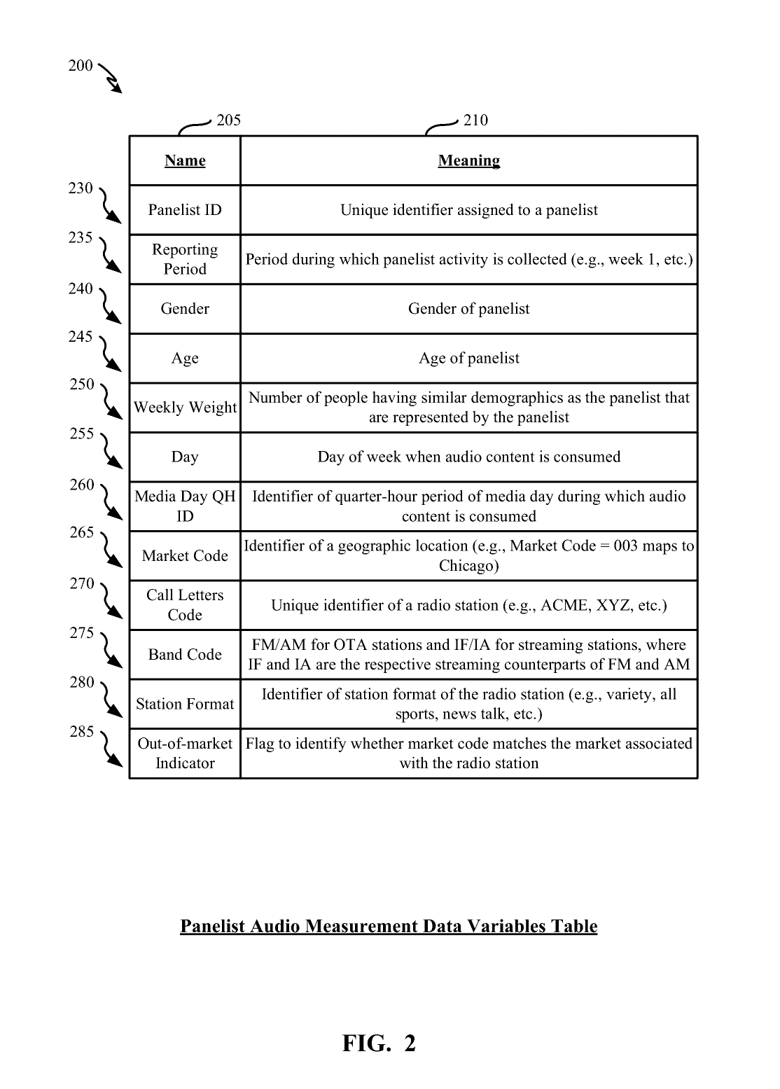

In the illustrated example of FIG. 1, the example central facility 108 includes the example panelist audio measurement data database 112 to record data (e.g., the example audience measurement data 103) provided by the audience measurement system(s) 102 via the example data interface 110. An example data table 200 of the illustrated example of FIG. 2 illustrates example data variables that may be recorded in the example panelist audio measurement data database 112. The example panelist audio measurement data database 112 may be implemented by a volatile memory (e.g., a Synchronous Dynamic Random Access Memory (SDRAM), Dynamic Random Access Memory (DRAM), RAMBUS Dynamic Random Access Memory (RDRAM), etc.) and/or a non-volatile memory (e.g., flash memory). The example panelist audio measurement data database 112 may additionally or alternatively be implemented by one or more double data rate (DDR) memories, such as DDR, DDR2, DDR3, mobile DDR (mDDR), etc. The example panelist audio measurement data database 112 may additionally or alternatively be implemented by one or more mass storage devices such as hard disk drive(s), compact disk drive(s), digital versatile disk drive(s), etc. While in the illustrated example the panelist audio measurement data database 112 is illustrated as a single database, the panelist audio measurement data database 112 may be implemented by any number and/or type(s) of databases.

The example central facility 108 of the illustrated example of FIG. 1 combines multiple disparate data sets (e.g., panelist information, audio exposure data, etc.) to enable calculating an unduplication factor. In the illustrated example of FIG. 1, the example central facility 108 includes the example panelist data manager 114 and the example activity data manager 116 to identify information of interest in the example panelist audio measurement data database 112 at the respective levels. For example, the panelist data manager 114 may parse the panelist audio measurement data database 112 to identify panelist information for panelists who satisfied an activity threshold (e.g., who recorded exposure to audio content at least six days in a week). In the illustrated example of FIG. 1, if the example panelist data manager 114 identifies panelist information that satisfies the activity threshold, the panelist data manager 114 stores the identified panelist information in the example listening data database 122. For example, the panelist data manager 114 may store the panelist identifier, the reporting period identifier, gender, age and weekly weight corresponding to the identified panelist information in the listening data database 122.

The example activity data manager 116 of the illustrated example of FIG. 1 parses the panelist audio measurement data database 112 to identify audio exposure data that satisfies a listening duration threshold during a quarter-hour (e.g., listened at least five minutes during a quarter-hour period). In the illustrated example of FIG. 1, if the example activity data manager 116 identifies audio exposure data that satisfies the listening duration threshold, the activity data manager 116 stores the identified audio exposure data in the example listening data database 122. For example, the activity data manager 116 may store the panelist identifier, the reporting period identifier, the day of exposure identifier, the media day QH ID, the market code, the call letters code, the band code and station format information corresponding to the identified audio exposure data in the listening data database 122. In some examples, the activity data manager 116 merges the identified audio exposure data with the panelist information in the listening data database 122 using the panelist identifier and the reporting period identifier.

The example central facility 108 of the illustrated example of FIG. 1 includes the example station data manager 118 to parse the listening data database 122 to identify listening data (e.g., the merged panelist information and audio exposure data) associated with qualifying stations. In the illustrated example, the station data manager 118 uses an example list of OTA stations 120 to identify qualifying OTA stations in the listening data. For example, the list of OTA stations 120 may include market code, call letters code, band code and station format information for OTA stations that have counterpart streaming stations. The example station data manager 118 may also use the list of OTA stations 120 to identify qualifying streaming stations in the listening data. For example, a qualifying streaming station will have the same market code, call letters code and station format as an OTA station included in the list of OTA stations 120 and will have the digital counterpart of the band code of the OTA station. For example, the digital counterpart band code for an FM OTA station is “IF” and the digital counterpart band code for an AM OTA station is “IA.” A station that is identified as a qualifying station may result in a duplicated audience count. In the illustrated example of FIG. 1, the example station data manager 118 removes (e.g., discards, deletes, etc.) listening data included in the listening data database 122 that does not correspond to a qualifying radio station.

In the illustrated example of FIG. 1, the example central facility 108 includes the example listening data database 122 to record listening data provided by the example panelist data manager 116, the example activity data manager 118 and/or the example station data manager 118. The example listening data database 122 may be implemented by a volatile memory (e.g., an SDRAM, DRAM, RDRAM, etc.) and/or a non-volatile memory (e.g., flash memory). The example listening data database 122 may additionally or alternatively be implemented by one or more DDR memories, such as DDR, DDR2, DDR3, mDDR, etc. The example listening data database 122 may additionally or alternatively be implemented by one or more mass storage devices such as hard disk drive(s), compact disk drive(s), digital versatile disk drive(s), etc. While in the illustrated example the listening data database 122 is illustrated as a single database, the listening data database 122 may be implemented by any number and/or type(s) of databases.

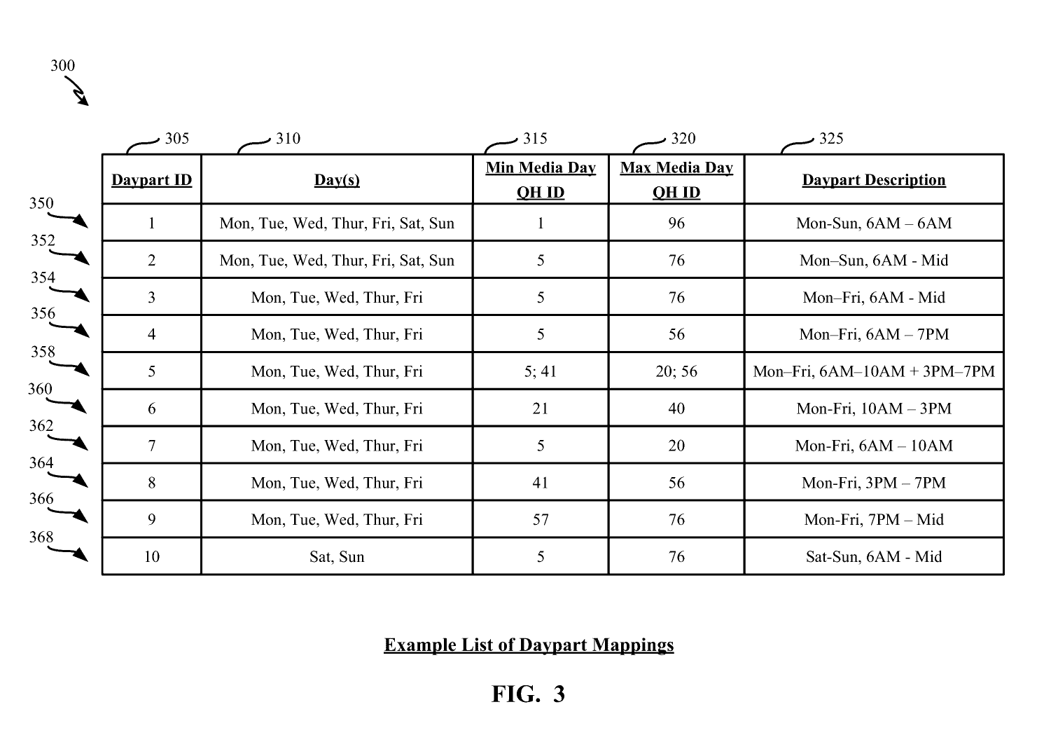

In the illustrated example of FIG. 1, the central facility 108 includes the example daypart manager 124 to associate listening data included in the listening data database 122 with one or more dayparts. For example, the daypart manager 124 may use the day of exposure identifier and the media day QH ID to associate the listening data with a daypart. In the illustrated example of FIG. 1, the example daypart manager 124 accesses an example list of daypart mappings 125 including the one or more days of exposures and the range of media day QH IDs that qualify for the one or more dayparts. Example data table 300 of the illustrated example of FIG. 3 illustrates an example implementation of the list of daypart mappings 125.

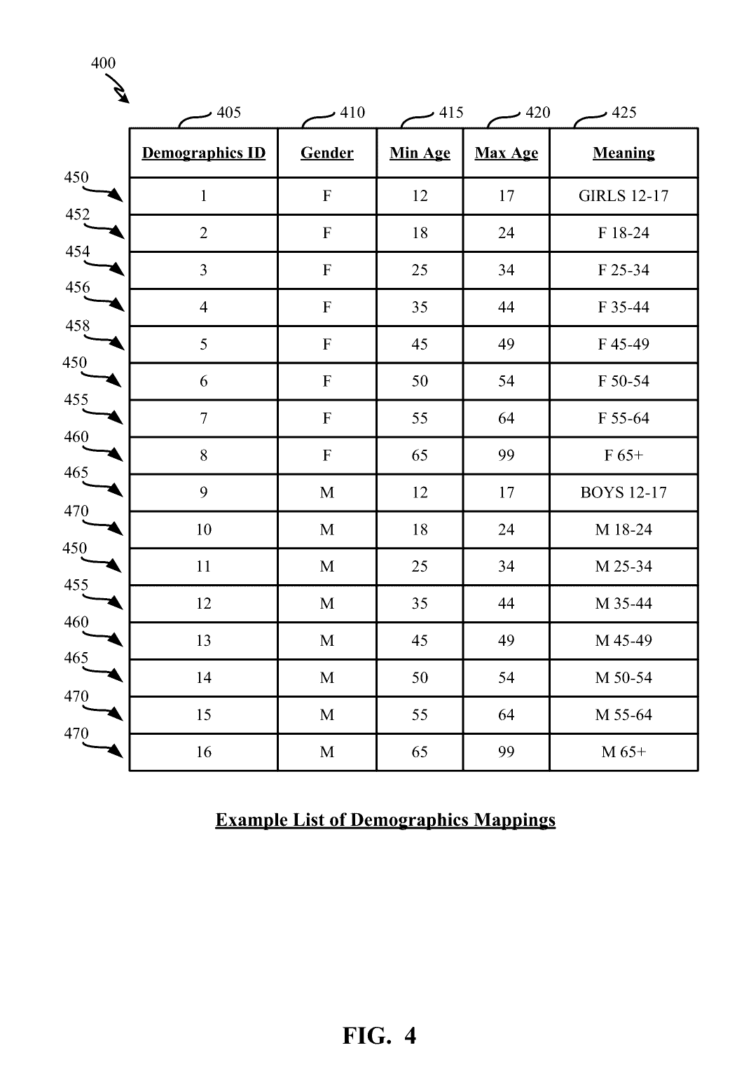

In the illustrated example of FIG. 1, the central facility 108 includes the example demographics manager 126 to associate listening data included in the listening data database 122 with a demographic group. For example, the demographics manager 126 may use the gender and age information included in the listening data to associate the listening data with a demographic group. In the illustrated example of FIG. 1, the example demographics manager 126 accesses an example list of demographics mappings 127 including the gender and the range of ages that qualify for a respective demographic group. Example data table 400 of the illustrated example of FIG. 4 illustrates an example implementation of the list of demographics mappings 127.

In the illustrated example of FIG. 1, the central facility 108 includes the example listening data manager 128 to provide listening data from the listening data database 122 based on combinations of daypart, demographic group and reporting period. For example, the listening data manager 128 may select a daypart, demographic group and reporting period combination and retrieve listening data from that listening data database 122 with the same combination. In the illustrated example, the listening data manager 128 stores the retrieved listening data in the example filtered listening data database 130.

The example listening data manager 128 of FIG. 1 may also collapse the entries included in the filtered listening data database 130 by removing one or more entries associated with the same panelist and radio station. Because entries in the filtered listening data database 130 are already filtered so that they have a common daypart, demographic group and reporting period, entries with the same panelist and radio station are, thus, duplicated audience counts and may be removed. For example, the listening data manager 128 may process the filtered listening data in the filtered listening data database 130 to remove entries with the same panelist identifier, call letters code and band code.

The example filtered listening data database 130 may be implemented by a volatile memory (e.g., SDRAM, DRAM, RDRAM, etc.) and/or a non-volatile memory (e.g., flash memory). The example filtered listening data database 130 may additionally or alternatively be implemented by one or more DDR memories, such as DDR, DDR2, DDR3, mDDR, etc. The example filtered listening data database 130 may additionally or alternatively be implemented by one or more mass storage devices such as hard disk drive(s), compact disk drive(s), digital versatile disk drive(s), etc. While in the illustrated example the filtered listening data database 130 is illustrated as a single database, the filtered listening data database 130 may be implemented by any number and/or type(s) of databases.

In the illustrated example of FIG. 1, the central facility 108 includes the example digital Cume calculator 132 to calculate a digital Cume using the filtered listening data included in the filtered listening data database 130. For example, the digital Cume calculator 132 may identify filtered listening data entries corresponding to exposure to a streaming station using, for example, the band codes of the filtered listening data. The example digital Cume calculator 132 then sums the weekly weights associated with the identified filtered listening data to calculate a digital Cume for the given combination of daypart, demographic group and reporting period selected by the listening data manager 128.

In the illustrated example of FIG. 1, the central facility 108 includes the example duplicate Cume calculator 134 to calculate a duplicate Cume using the filtered listening data included in the filtered listening data database 130. For example, the duplicate Cume calculator 134 may identify filtered listening data entries where the same panelist is listening to both counterparts of a broadcast station. The example duplicate Cume calculator 134 may use the call letters code and the band code to identify duplication between the OTA station and the streaming station. The example duplicate Cume calculator 134 then sums the weekly weights associated with the streaming station entries of the duplicate entries to calculate a duplicate Cume for the given combination of daypart, demographic group and reporting period selected by the listening data manager 128.

In the illustrated example of FIG. 1, the central facility 108 includes the example unduplication factor (UF) calculator 136 to calculate an unduplication factor for a specified daypart-demographic group pairing. For example, the UF calculator 136 may sum the digital Cume for a plurality of reporting periods (e.g., across 12 weeks in a rolling period) at the daypart-demographic group level to calculate a sum of digital Cume. The example UF calculator 136 may also sum the duplicate Cume for the same number of reporting periods at the daypart-demographic group level to calculate a sum of duplicate Cume. The example UF calculator 136 may then use Equation 1 below to calculate the UF for the specified daypart-demographic group pairing.

$$U F = 1 - \frac{Sum of duplicate Cume}{Sum of digital Cume} \qquad Equation 1$$

In some instances, the sum of digital Cume for a specified daypart-demographic group pairing may be zero. For example, panelists in the specified daypart-demographic group pairing may not listen to the streaming station component of a broadcast station. In some such instances, the example UF calculator 136 calculates the UF for the specified daypart-demographic group pairing by determining the average unduplication factor for the same daypart but at the gender level rather than at the demographic group level. For example, if the sum of digital Cume for a first daypart (e.g., Sunday 6 AM-10 AM) and first demographic group (e.g., females 18-20) pairing is zero, the example UF calculator 136 calculates an average unduplication factor for the first daypart and gender (e.g., females) pairing. The example UF calculator 136 then assigns the average unduplication factor to the specified daypart-demographic group pairing.

In the illustrated example of FIG. 1, the central facility 108 includes the example UF matrix generator 140 to generate a matrix of unduplication factors at daypart-demographic group pairings. In some examples, the daypart-demographic group pairings used to calculate the unduplication factors may be different than the daypart-demographic group pairings requested by, for example, the client 150. For example, a requested daypart and/or a requested demographic group may be relatively more granular than the dayparts included in the example list of daypart mappings 125 accessed by the example daypart manager 124 and/or the example list of demographics mappings 127 accessed by the example demographics manager 126. In some such examples, the example UF matrix generator 140 imputes the unduplication factor calculated for the relatively broader daypart and/or demographic group to the more granular daypart and/or demographic group. For example, the list of daypart mappings 125 may identify a first daypart as Sunday 6 AM-3 PM, while the client 150 may split this same daypart into two dayparts (e.g., Sunday 6 AM-11 AM and Sunday 11 AM-3 PM). The example UF matrix generator 140 may then use the unduplication factor calculated for the first daypart for the two smaller dayparts.

In the illustrated example of FIG. 1, the central facility 108 includes the example total Cume calculator 142 to calculate duplication corrected total Cume 144 for the broadcast station. For example, the total Cume calculator 142 may use Equation 2 below to calculate a total Cume 144.

Total Cume=OTA Cume+UF*Total Digital Cume Equation 2

In Equation 2 above, the OTA Cume and the total digital Cume are provided by the client 150 with the request for the one or more reports. In the illustrated example, the total Cume, the OTA Cume, the UF and the total digital Cume values are determined at a same specified daypart-demographic group pairing.

In some examples, the OTA Cume for a particular daypart-demographic group pairing may be zero. For example, panelists in the particular demographic group may not listen to the OTA station component of the broadcast station. In some such examples, the example total Cume calculator 142 uses the total digital Cume as the total Cume for the particular daypart-demographic group pairing. Because the OTA Cume indicates no audience count, there will be no overlap in audience counts between the OTA Cume and the total digital Cume, and, thus, the total Cume calculator 142 does not apply the unduplication factor to the total digital Cume. The AME 106 may then provide the total Cume values 144 for the respective daypart-demographic group pairings to the client 150.

FIG. 2 is an example data table 200 that lists panelist audio measurement data variables that the example data interface 110 of FIG. 1 may store in the example panelist audio measurement data database 112 of FIG. 1. In the illustrated example of FIG. 2, the panelist audio measurement data variables represent the data collected and/or provided by the audience measurement system(s) 102 of FIG. 1. For example, the panelist audio measurement data variables may include the audio measurement data 103 collected via, for example, people meters operating in statistically-selected households, set-top boxes and/or other media devices (e.g., such as digital video recorders, personal computers, tablet computers, smartphones, etc.) capable of monitoring and returning monitored data for media presentations, etc.

The example data table 200 of the illustrated example of FIG. 2 includes a variable name identifier column 205 and a variable meaning identifier column 210. The example variable name identifier column 205 indicates example variables that may be associated with exposure to audio content. The example variable meaning identifier column 210 provides a brief description of the value associated with the corresponding variable. While two example variable identifier columns are represented in the example data table 200 of FIG. 2, more or fewer variable identifier columns may be represented in the example data table 200.

The example data table 200 of the illustrated example of FIG. 2 includes twelve example rows corresponding to example panelist audio measurement data variables. The first example row 230 indicates the “panelist ID” variable corresponds to a unique identifier assigned to a panelist. For example, panelists who are provided people meters may be assigned a panelist identifier to monitor the media exposure of the panelist. In the illustrated example, the panelist identifier is an obfuscated alphanumeric string to protect the identity of the panelist. In some examples, the panelist identifier is obfuscated in a manner so that the same obfuscated panelist identifier information corresponds to the same panelist. In this manner, user activities may be monitored for particular users without exposing sensitive information regarding the panelist. However, any other approach to protecting the privacy of a panelist may additionally or alternatively be used.

In the example data table 200 of FIG. 2, the second example row 235 indicates the “reporting period” variable corresponds to a period during which panelist activity is collected. For example, panelist activity may be collected in weekly intervals.

In the example data table 200 of FIG. 2, the third and fourth example rows 240, 245 identify demographic information associated with the panelist. For example, the third example row 240 indicates the “gender” variable corresponds to the gender of the panelist. The fourth example row 245 indicates the “age” variable corresponds to the age of the panelist. In some examples, the gender and age associated with the panelist are used to identify a demographic group to which the panelist is classified.

In the example data table 200 of FIG. 2, the fifth example row 250 indicates the “weekly weight” variable corresponds to a number of people having similar demographic information that are represented by the corresponding panelist. For example, the weekly weight value assigned to a panelist may indicate how influential the panelist is to people having the same demographic information.

In the example data table 200 of FIG. 2, the sixth example row 255 indicates the “day” variable corresponds to the day of the week when audio content was consumed. The seventh example row 260 indicates the “media day QH ID” variable corresponds to an identifier of a quarter-hour period of a media day during which audio content is consumed. In the illustrated example, the quarter-hour periods start at 5 AM. Thus, the first QH corresponds to 5 AM-5:15 AM, the fifth QH corresponds to 6 AM-6:15 AM, etc. The day and media day QH ID may be used to assign the audio content exposure to one or more dayparts.

In the example data table 200 of FIG. 2, the eighth through eleventh example rows identify a radio station. For example, the eighth example row 265 indicates the “market code” variable corresponds to an identifier of a geographic location. For example, the market code “003” may map to Chicago, Ill. The ninth example row 270 indicates the “call letters code” variable corresponds to a unique identifier of a radio station. The tenth example row 275 indicates the “band code” variable may be used to determine whether the radio station is an OTA station (e.g., band code=AM or FM) or a streaming station (e.g., band code=IA or IF). In the illustrated example, the band code “IA” is the digital counterpart for an AM OTA station and the band code “IF” is the digital counterpart for an FM OTA station. The eleventh example row 280 indicates the “station format” variable corresponds to an identifier of a station format (e.g., variety, all sports, news talk, etc.) of the radio station. In some examples, the station format may be useful in determining the type of audio content presented by the radio station.

In the example data table 200 of FIG. 2, the twelfth example row 285 indicates the “out-of-market indicator” variable is a flag to identify whether a market code matches the market associated with the radio station. For example, an OTA station may be based in and broadcast their audio content from Chicago, Ill. However, it may be possible to listen to the OTA station while in a relatively nearby city such as Milwaukee, Wis. In such instances, audio exposure data where the Chicago-based OTA station was listened to in Milwaukee is out-of-market and may be flagged accordingly.

While twelve example panelist audio measurement data variables are represented in the example data table 200 of FIG. 2, more or fewer panelist audio measurement data variables may be represented in the example data table 200 corresponding to the many panelist audio measurement data variables that may be collected and/or provided by the audience measurement system(s) 102 of FIG. 1.

FIG. 3 is an example data table 300 that illustrates an example implementation of the example list of daypart mappings 125 that may be accessed by the example daypart manager 124 of FIG. 1. The example data table 300 of the illustrated example includes a daypart identifier column 305, an example day(s) identifier column 310, an example minimum media day QH identifier column 315, an example maximum media day QH identifier column 320 and an example daypart description column 325. The example daypart identifier column 305 identifies a particular daypart. The example day(s) identifier column 310 identifies the one or more days of the week that are included in the corresponding daypart. The example minimum media day QH identifier column 315 and the example maximum media day QH identifier column 320 identify a range of media day QH values that are included in the corresponding daypart. In the illustrated example of FIG. 3, the first media day quarter-hour (e.g., media day QH=1) corresponds to the 5 AM-5:15 AM quarter hour. The example daypart description column 325 provides a brief description of the daypart. While five example identifier columns are represented in the example data table 300 of FIG. 3, more or fewer identifier columns may be represented in the example data table 300.

The example data table 300 of the illustrated example of FIG. 3 includes ten example rows corresponding to ten example dayparts. The first example row 350 indicates that a daypart “1” corresponds to all times of the week (e.g., Mon-Sun, 6 AM-6 AM). As a result, listening data associated with any day of the week and at any quarter-hour of the day is included in the daypart “1.”

In the example data table 300 of FIG. 3, the second example row 352 indicates that a daypart “2” corresponds to Monday to Sunday 6 AM-Mid. As described above, the first media day quarter-hour corresponds to the 5 AM-5:15 AM quarter hour. In the illustrated example, the minimum media day QH of “5” corresponds to the 6 AM-6:15 AM quarter-hour and the maximum media day QH of “76” corresponds to the 11:45 PM-12 AM quarter-hour.

In the example data table 300 of FIG. 3, the third example row 354 indicates that a daypart “3” corresponds to Monday to Friday and corresponds to the 6 AM-midnight time range. For example, the minimum media day QH identifier “5” corresponds to 6 AM and the maximum media day QH identifier “76” corresponds to midnight.

In the example data table 300 of FIG. 3, the fourth example row 356 indicates that a daypart “4” corresponds to Monday to Friday and corresponds to the 6 AM-7 PM time range. For example, the minimum media day QH identifier “5” corresponds to 6 AM and the maximum media day QH identifier “56” corresponds to 7 PM.

In the example data table 300 of FIG. 3, the fifth example row 358 indicates that a daypart “5” corresponds to Monday to Friday. The fifth example row 358 also indicates that the daypart “5” also corresponds to two different time ranges (e.g., “6 AM-10 AM” and “3 PM-7 PM”) and, thus, there are two minimum media day QH identifiers and two maximum media day QH identifiers. For example, the first minimum media day QH identifier “5” corresponds to 6 AM and the second medium media day QH identifier “41” corresponds to 3 PM. The first maximum media day QH identifier “20” corresponds to 10 AM and the second maximum media day QH identifier “56” corresponds to 7 PM.

In the example data table 300 of FIG. 3, the sixth example row 360 indicates that a daypart “6” corresponds to Monday to Friday and corresponds to the 10 AM-3 PM time range. For example, the minimum media day QH identifier “21” corresponds to 10 AM and the maximum media day QH identifier “40” corresponds to 3 PM.

In the example data table 300 of FIG. 3, the seventh example row 362 indicates that a daypart “7” corresponds to Monday to Friday and corresponds to the 6 AM-10 AM time range. For example, the minimum media day QH identifier “5” corresponds to 6 AM and the maximum media day QH identifier “20” corresponds to 10 AM.

In the example data table 300 of FIG. 3, the eighth example row 364 indicates that a daypart “8” corresponds to Monday to Friday and corresponds to the 3 PM-7 PM time range. For example, the minimum media day QH identifier “41” corresponds to 3 PM and the maximum media day QH identifier “56” corresponds to 7 PM.

In the example data table 300 of FIG. 3, the ninth example row 366 indicates that a daypart “9” corresponds to Monday to Friday and corresponds to the 7 PM-midnight time range. For example, the minimum media day QH identifier “57” corresponds to 7 PM and the maximum media day QH identifier “76” corresponds to midnight.

In the example data table 300 of FIG. 3, the tenth example row 368 indicates that a daypart “10” corresponds to Saturday to Sunday and corresponds to the 6 AM-midnight time range. For example, the minimum media day QH identifier “5” corresponds to 6 AM and the maximum media day QH identifier “76” corresponds to midnight.

While ten example dayparts are represented in the example data table 300 of FIG. 3, more or fewer dayparts may be represented in the example data table 300 corresponding to the many levels of granularity available to day and time range pairings.

FIG. 4 is an example data table 400 that illustrates an example implementation of the example list of demographics mappings 127 that may be accessed by the example demographics manager 126 of FIG. 1. The example data table 400 of the illustrated example includes a demographic group identifier column 405, an example gender identifier column 410, an example minimum age identifier column 415, an example maximum age identifier column 420 and an example demographic group description column 425. The example demographic group identifier column 405 identifies a particular demographic group. The example gender identifier column 410 identifies the gender that is included in the corresponding demographic group. The example minimum age identifier column 415 and the example maximum age identifier column 420 identify a range of ages that are included in the corresponding demographic group. The example demographic group description column 425 provides a brief description of the demographic group. While five example identifier columns are represented in the example data table 400 of FIG. 4, more or fewer identifier columns may be represented in the example data table 400.

The example data table 400 of the illustrated example of FIG. 4 includes sixteen example rows corresponding to sixteen example demographic groups. The first example row 450 indicates that a demographic group “1” corresponds to girls between the ages of 12 and 17.

In the example data table 400 of FIG. 4, the second example row 452 indicates that a demographic group “2” corresponds to females between the ages of 18 and 24.

In the example data table 400 of FIG. 4, the third example row 454 indicates that a demographic group “3” corresponds to females between the ages of 25 and 34.

In the example data table 400 of FIG. 4, the fourth example row 456 indicates that a demographic group “4” corresponds to females between the ages of 35 and 44.

In the example data table 400 of FIG. 4, the fifth example row 458 indicates that a demographic group “5” corresponds to females between the ages of 45 and 49.

In the example data table 400 of FIG. 4, the sixth example row 460 indicates that a demographic group “6” corresponds to females between the ages of 50 and 54.

In the example data table 400 of FIG. 4, the seventh example row 462 indicates that a demographic group “7” corresponds to females between the ages of 55 and 64.

In the example data table 400 of FIG. 4, the eighth example row 464 indicates that a demographic group “8” corresponds to females who are 65 and older.

In the example data table 400 of FIG. 4, the ninth example row 466 indicates that a demographic group “9” corresponds to boys between the ages of 12 and 17.

In the example data table 400 of FIG. 4, the tenth example row 468 indicates that a demographic group “10” corresponds to males between the ages of 18 and 24.

In the example data table 400 of FIG. 4, the eleventh example row 470 indicates that a demographic group “11” corresponds to males between the ages of 25 and 34.

In the example data table 400 of FIG. 4, the twelfth example row 472 indicates that a demographic group “12” corresponds to males between the ages of 35 and 44.

In the example data table 400 of FIG. 4, the thirteenth example row 474 indicates that a demographic group “13” corresponds to males between the ages of 45 and 49.

In the example data table 400 of FIG. 4, the fourteenth example row 476 indicates that a demographic group “14” corresponds to males between the ages of 50 and 54.

In the example data table 400 of FIG. 4, the fifteenth example row 478 indicates that a demographic group “15” corresponds to males between the ages of 55 and 64.

In the example data table 400 of FIG. 4, the sixteenth example row 480 indicates that a demographic group “16” corresponds to males who are 65 and older.

While sixteen example demographic groups are represented in the example data table 400 of FIG. 4, more or fewer dayparts may be represented in the example data table 400 corresponding to the many levels of granularity available to gender and age range pairings.

While an example manner of implementing the central facility 108 of FIG. 1 is illustrated in FIG. 1, one or more of the elements, processes and/or devices illustrated in FIG. 1 may be combined, divided, re-arranged, omitted, eliminated and/or implemented in any other way. Further, the example data interface 110, the example panelist audio measurement data database 112, the example panelist data manager 114, the example activity data manager 116, the example station data manager 118, the example listening data database 122, the example daypart manager 124, the example demographics manager 126, the example listening data manager 128, the example filtered listening data database 130, the example digital Cume calculator 132, the example duplicate Cume calculator 134, the example UF calculator 136, the example UF matrix generator 140, the example total Cume calculator 142 and/or, more generally, the example central facility 108 of FIG. 1 may be implemented by hardware, software, firmware and/or any combination of hardware, software and/or firmware. Thus, for example, any of the example data interface 110, the example panelist audio measurement data database 112, the example panelist data manager 114, the example activity data manager 116, the example station data manager 118, the example listening data database 122, the example daypart manager 124, the example demographics manager 126, the example listening data manager 128, the example filtered listening data database 130, the example digital Cume calculator 132, the example duplicate Cume calculator 134, the example UF calculator 136, the example UF matrix generator 140, the example total Cume calculator 142 and/or, more generally, the example central facility 108 of FIG. 1 could be implemented by one or more analog or digital circuit(s), logic circuits, programmable processor(s), application specific integrated circuit(s) (ASIC(s)), programmable logic device(s) (PLD(s)) and/or field programmable logic device(s) (FPLD(s)). When reading any of the apparatus or system claims of this patent to cover a purely software and/or firmware implementation, at least one of the example data interface 110, the example panelist audio measurement data database 112, the example panelist data manager 114, the example activity data manager 116, the example station data manager 118, the example listening data database 122, the example daypart manager 124, the example demographics manager 126, the example listening data manager 128, the example filtered listening data database 130, the example digital Cume calculator 132, the example duplicate Cume calculator 134, the example UF calculator 136, the example UF matrix generator 140, the example total Cume calculator 142 and/or, more generally, the example central facility 108 of FIG. 1 is/are hereby expressly defined to include a tangible computer readable storage device or storage disk such as a memory, a digital versatile disk (DVD), a compact disk (CD), a Blu-ray disk, etc. storing the software and/or firmware. Further still, the example central facility 108 of FIG. 1 may include one or more elements, processes and/or devices in addition to, or instead of, those illustrated in FIG. 1, and/or may include more than one of any or all of the illustrated elements, processes and devices.

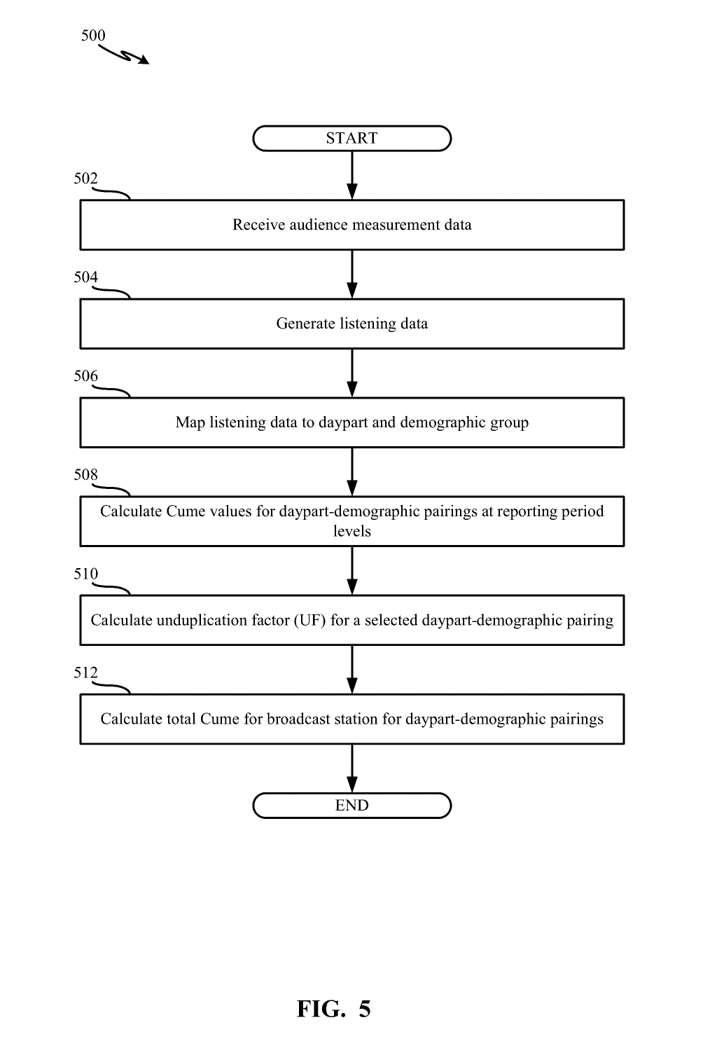

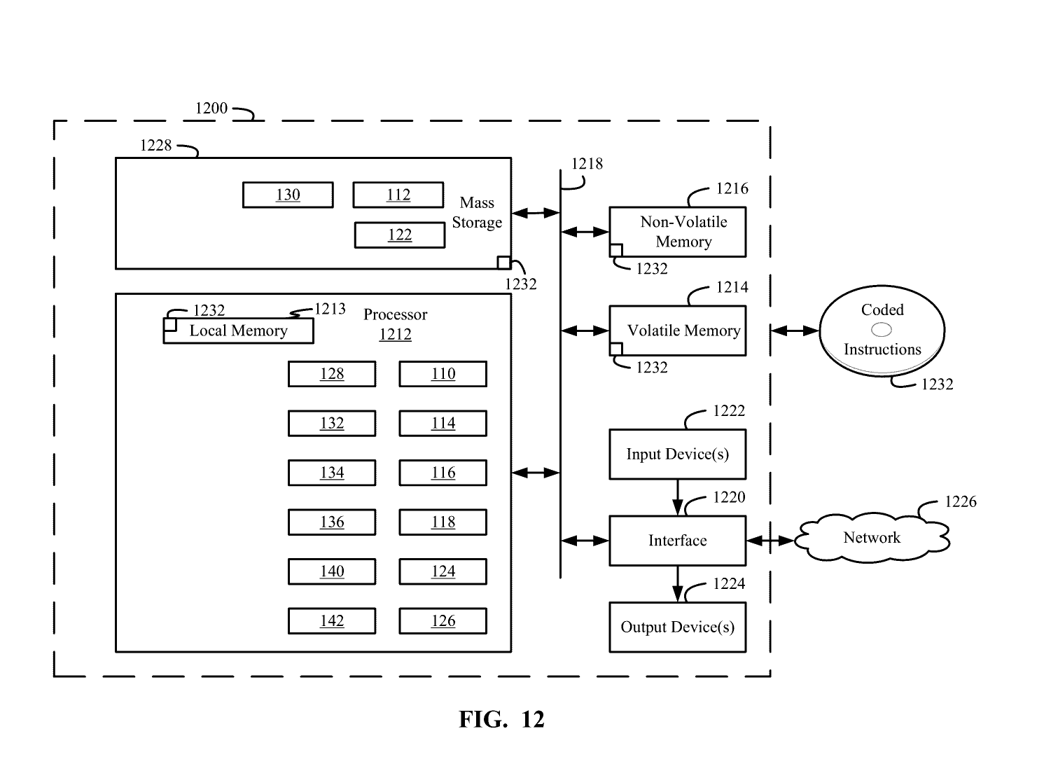

Flowcharts representative of example machine readable instructions for implementing the example central facility of FIG. 1 are shown in FIGS. 5-9 and/or 10. In this example, the machine readable instructions comprise a program for execution by a processor such as the processor 1212 shown in the example processor platform 1200 discussed below in connection with FIG. 12. The program may be embodied in software stored on a tangible computer readable storage medium such as a CD-ROM, a floppy disk, a hard drive, a digital versatile disk (DVD), a Blu-ray disk, or a memory associated with the processor 1212, but the entire program and/or parts thereof could alternatively be executed by a device other than the processor 1212 and/or embodied in firmware or dedicated hardware. Further, although the example program is described with reference to the flowcharts illustrated in FIGS. 5-9 and/or 10, many other methods of implementing the example central facility 108 may alternatively be used. For example, the order of execution of the blocks may be changed, and/or some of the blocks described may be changed, eliminated, or combined.

As mentioned above, the example processes of FIGS. 5-9 and/or 10 may be implemented using coded instructions (e.g., computer and/or machine readable instructions) stored on a tangible computer readable storage medium such as a hard disk drive, a flash memory, a read-only memory (ROM), a compact disk (CD), a digital versatile disk (DVD), a cache, a random-access memory (RAM) and/or any other storage device or storage disk in which information is stored for any duration (e.g., for extended time periods, permanently, for brief instances, for temporarily buffering, and/or for caching of the information). As used herein, the term tangible computer readable storage medium is expressly defined to include any type of computer readable storage device and/or storage disk and to exclude propagating signals and to exclude transmission media. As used herein, “tangible computer readable storage medium” and “tangible machine readable storage medium” are used interchangeably. Additionally or alternatively, the example processes of FIGS. 5-9 and/or 10 may be implemented using coded instructions (e.g., computer and/or machine readable instructions) stored on a non-transitory computer and/or machine readable medium such as a hard disk drive, a flash memory, a read-only memory, a compact disk, a digital versatile disk, a cache, a random-access memory and/or any other storage device or storage disk in which information is stored for any duration (e.g., for extended time periods, permanently, for brief instances, for temporarily buffering, and/or for caching of the information). As used herein, the term non-transitory computer readable medium is expressly defined to include any type of computer readable storage device and/or storage disk and to exclude propagating signals and to exclude transmission media. As used herein, when the phrase “at least” is used as the transition term in a preamble of a claim, it is open-ended in the same manner as the term “comprising” is open ended. “Comprising” and all other variants of “comprise” are expressly defined to be open-ended terms. “Including” and all other variants of “include” are also defined to be open-ended terms. In contrast, the term “consisting” and/or other forms of “consist” are defined to be close-ended terms.

FIG. 5 is a flowchart representative of example machine-readable instructions 500 that may be executed by the example central facility 108 of FIG. 1 to enable duplication correction for broadcast station audience measurement data. The example instructions 500 of FIG. 5 begin at block 502 when the example central facility 108 receives audience measurement data 103 from the example audience measurement system(s) 102 of FIG. 1. For example, the example data interface 110 (FIG. 1) may periodically obtain and/or retrieve example panelist information and/or audio exposure data. In some examples, the data interface 110 may obtain and/or retrieve the example audience measurement data 103 aperiodically and/or as a one-time event. The example data interface 110 stores the audience measurement data 103 in the example panelist audio measurement data database 112 (FIG. 1).

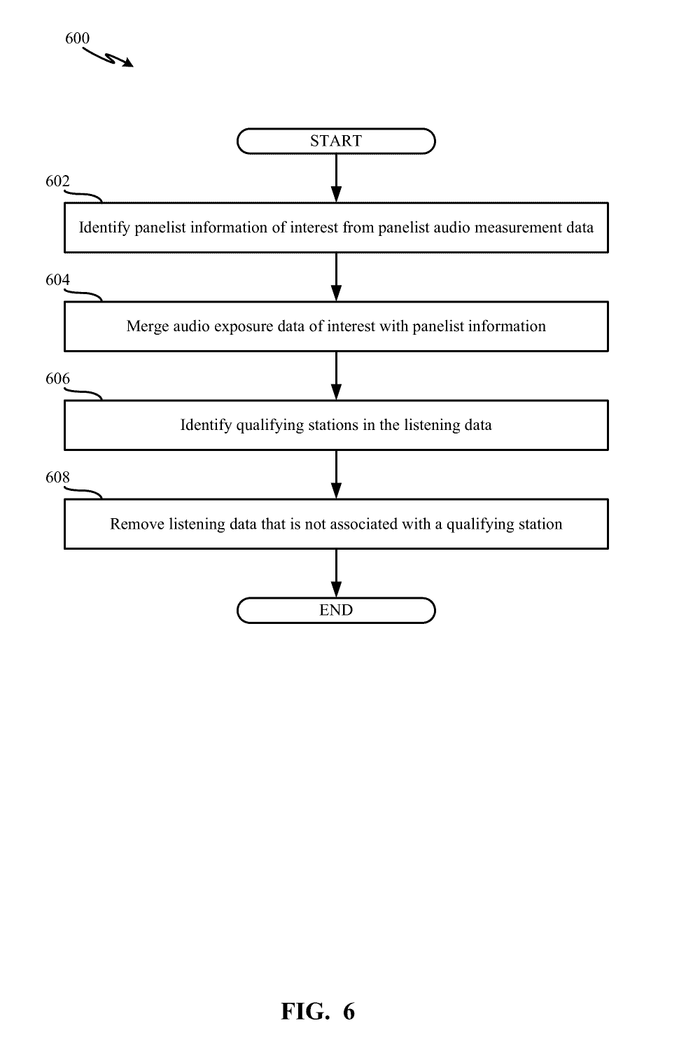

At block 504, the example central facility 108 generates listening data. For example, the example panelist data manager 114, the example activity data manager 116 and/or the example station data manager 118 of FIG. 1 may parse the panelist audio measurement data database 112 and identify information of interest. The example panelist data manager 114, the example activity data manager 116 and/or the example station data manager 118 store information of interest in the example listening data database 112 and/or modify the information stored in the listening data database 112. An example approach to generate the listening data is described below in connection with FIG. 6.

At block 506, the example central facility 108 maps the listening data to a daypart and a demographic group. For example, the example daypart manager 124 of FIG. 1 may match the day of exposure information and the media day QH identifier of the listening data to a daypart included in a list of daypart mappings 125. The example demographics manager 126 of FIG. 1 may match the gender and age included with the listening data to a demographic group included in the list of demographics mappings 127. The example daypart manager 124 and the example demographics manager 126 update the listening data stored in the listening data database 122 with the daypart and demographic group.

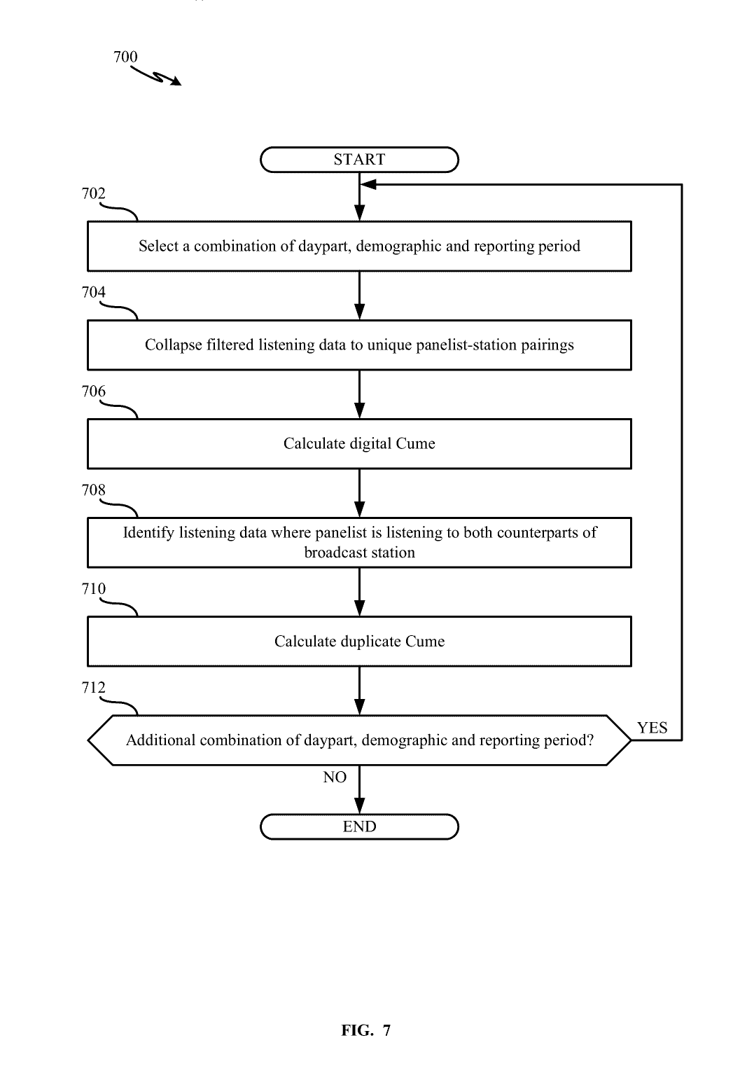

At block 508, the example central facility 108 calculates Cume values for listening data at the daypart, demographic group and reporting period levels. For example, the example digital Cume calculator 132 (FIG. 1) may identify unique panelist-station pairings in the listening data at a daypart, demographic group and reporting period level and calculate a digital Cume for the identified listening data corresponding to a streaming station. The example duplicate Cume calculator 134 (FIG. 1) may determine if any of the identified listening data corresponds to a panelist who listened to an OTA station and the counterpart streaming station and calculate a duplicate Cume for the identified panelists. An example approach to calculate the Cume values is described below in connection with FIG. 7.

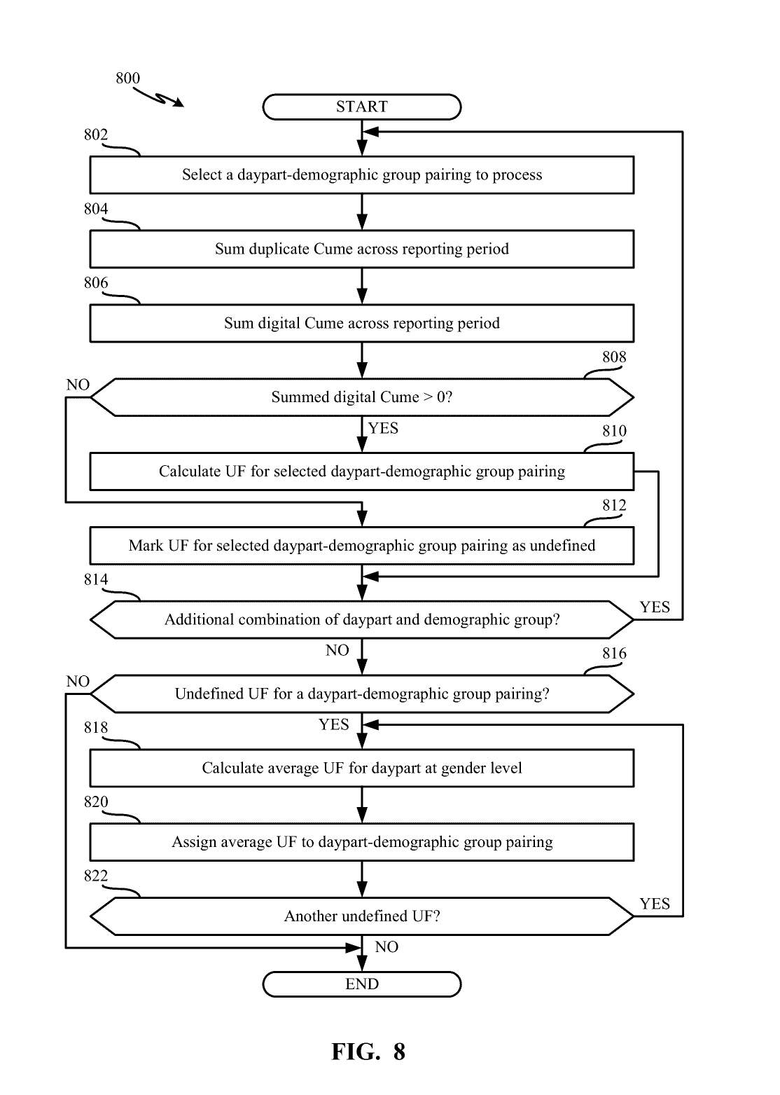

At block 510, the example central facility 108 calculates an unduplication factor for a selected daypart-demographic group pairing. For example, the example UF calculator 136 may use the digital Cume values and the duplicate Cume values across a plurality of reporting periods (e.g., a rolling 12 week period) to calculate the unduplication factor. An example approach to calculate the unduplication factor is described below in connection with FIG. 8.

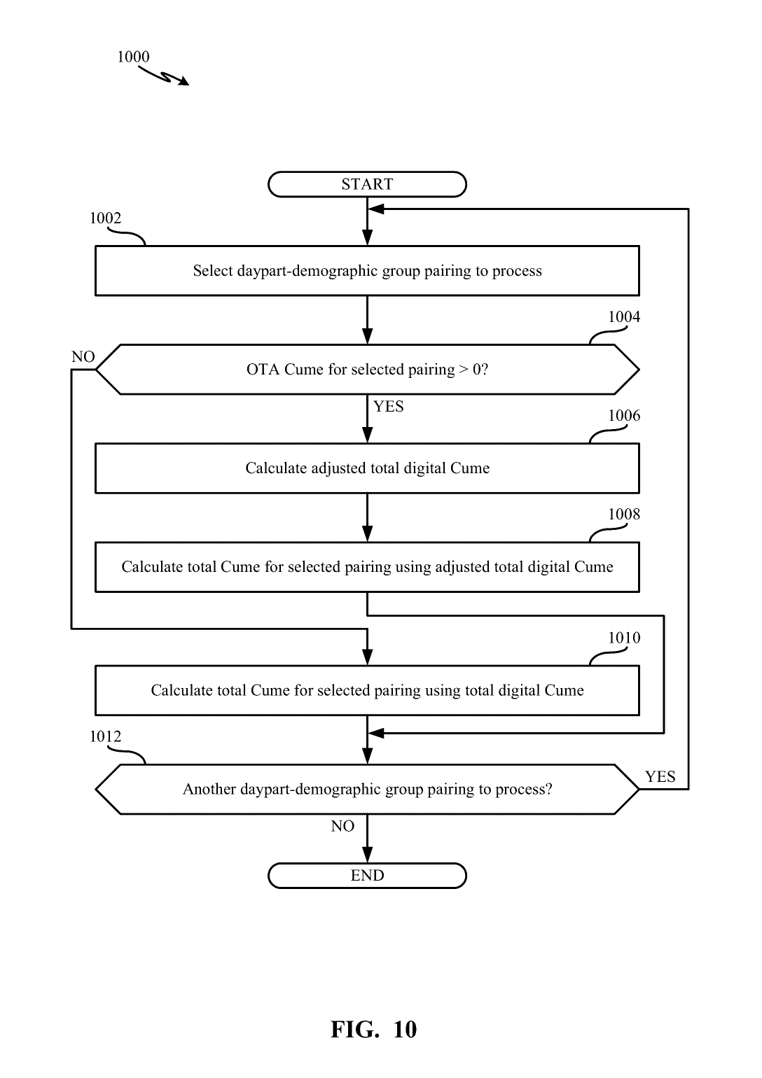

At block 512, the example central facility 108 calculates a total Cume for a broadcast station for daypart-demographic group pairings. For example, the total Cume calculator 142 may apply the unduplication factor for a given daypart-demographic group pairing to a total digital Cume at the same daypart-demographic group pairing and add the adjusted total digital Cume to the OTA Cume to calculate the total Cume for the broadcast station. An example approach to calculate the total Cume is described below in connection with FIG. 10. The example process 500 of FIG. 5 ends.

FIG. 6 is a flowchart representative of example machine-readable instructions 600 that may be executed by the example central facility 108 of FIG. 1 to generate listening data. The example instructions 600 of FIG. 6 begin at block 602 when the example central facility 108 identifies panelist information of interest. For example, the example panelist data manager 114 (FIG. 1) may identify panelist information associated with a panelist who satisfied an activity threshold. The example panelist data manager 114 stores the panelist information of interest in the listening data database 122 (FIG. 1).

At block 604, the example central facility 108 merges audio exposure data with the panelist information of interest. For example, the example activity data manager 116 (FIG. 1) may identify audio exposure data corresponding to listening of the radio station for a listening duration threshold during a quarter-hour. The example activity data manager 116 may merge the identified audio exposure data of interest to the panelist information in the listening database 122 using the panelist identifier and the reporting period associated with the panelist information and the audio exposure data.

At block 606, the example central facility 108 identifies qualifying stations for deduplication in the listening data. For example, the example station data manager 118 (FIG. 1) may generate a list of qualifying streaming stations included in the listening data based on market code, call letters code, band code and station format information that correspond to an OTA station. In some examples, the station data manager 118 may access a list of qualifying OTA stations and generate a list of qualifying streaming stations based on the list of qualifying OTA stations. At block 608, the example station data manager 118 removes listening data that is not associated with a qualifying station from the listening data database 122. The example process 600 of FIG. 6 then ends.

FIG. 7 is a flowchart representative of example machine-readable instructions 700 that may be executed by the example central facility 108 of FIG. 1 to enable calculating Cume values for daypart-demographic group pairings at reporting period levels. The example instructions 700 of FIG. 7 begin at block 702 when the example central facility 108 selects a combination of daypart, demographic group and reporting period to process. For example, the example listening data manager 128 may retrieve listening data from the listening data database 122 of FIG. 1 based on a selected daypart (e.g., Monday-Sunday 6 AM-6 AM), demographic group (e.g., females age 25-34) and reporting period (e.g., week 1) combination. The example listening data manager 128 stores the filtered listening data in the example filtered listening data database 130 of FIG. 1.

At block 704, the example central facility 108 collapses the filtered listening data to identify unique panelist-station pairings. For example, the example listening data manager 128 may remove duplicate entries of the same panelist-station pairings. In some examples, the listening data manager 128 removes the duplicate entries based on a comparison of panelist identifier, call letters code and band code information associated with the listening data.

At block 706, the example central facility 108 calculates a digital Cume. For example, the example digital Cume calculator 132 (FIG. 1) parses the remaining listening data in the filtered listening data database 130 and identifies the listening data corresponding to exposure to streaming stations, for example, by examining the band code for the listening. The example digital Cume calculator 132 then sums the weekly weights associated with the identified listening data to calculate the digital Cume for the selected daypart, demographic group and reporting period combination.

At block 708, the example central facility 108 identifies listening data where a panelist is listening to both counterparts of a broadcast station. For example, the example duplicate Cume calculator 134 (FIG. 1) may examine the panelist identifier, call letter codes and band code information in the listening data to identify listening data where the panelist listed to the OTA station and the counterpart streaming station. At block 710, the example duplicate Cume calculator 134 calculate a duplicate Cume for the selected daypart, demographic group and reporting period combination by summing the weekly weights associated with the identified duplicate listening data.

At block 712, the example listening data manager 128 determines whether there is another combination of daypart, demographic group and reporting period to process. If, at block 712, the example listening data manager 128 determines there is another combination to process, control returns to block 702 and the example listening data manager 128 selects the next combination. If, at block 712, the example listening data manager 128 determines that there is not another combination of daypart, demographic group and reporting period to process, the example process 700 of FIG. 7 ends.

FIG. 8 is a flowchart representative of example machine-readable instructions 800 that may be executed by the example central facility 108 of FIG. 1 to calculate an unduplication factor for a given daypart-demographic group pairing. The example instructions 800 of FIG. 8 begin at block 802 when the example central facility 108 selects a daypart-demographic group pairing to process. At block 804, the example UF calculator 136 (FIG. 1) sums the duplicate Cume values calculated for the daypart-demographic group pairing across a plurality of reporting periods (e.g., across 12 weeks, etc.). At block 806, the example UF calculator 136 sums the digital Cume values calculated for the selected daypart-demographic group pairing across the plurality of reporting periods. If, at block 808, the example UF calculator 136 determines that the summed digital Cume is greater than zero, then, at block 810, the example UF calculator 136 calculates the UF for the selected daypart-demographic group pairing. For example, the example UF calculator 136 may use Equation 1 from above to calculate the UF. Control then proceeds to block 814 to determine if there is another combination of daypart and demographic group pairings to process.

If, at block 808, the example UF calculator 136 determines that the summed digital Cume is not greater than zero, then, at block 812, the UF calculator 136 marks the UF for the selected pairing as undefined.

At block 814, the UF calculator 136 determines whether there is another combination of daypart and demographic group pairings to process. If, at block 814, the UF calculator 136 determines that there is another combination to process, then control returns to block 802 to select another daypart-demographic group pairing to process.

If, at block 814, the UF calculator 136 determined that there is not another combination to process, then, at block 816, the example UF calculator 136 determines whether there is an unduplication factor marked as undefined. If, at block 816, the example UF calculator 136 determines that there is not an undefined unduplication factor (e.g., all unduplication factors have been calculated), then the example process 800 of FIG. 8 ends.

If, at block 816, the example UF calculator 136 determines that there is an undefined unduplication factor, then, at block 818, the example UF calculator 136 calculates an average UF for the daypart but at the gender level rather than at the demographic group level. For example, if the sum of digital Cume for a first daypart (e.g., Sunday 6 AM-10 AM) and first demographic group (e.g., females 18-20) pairing is zero, the example UF calculator 136 calculates an average unduplication factor for the first daypart and gender (e.g., females) pairing. At block 820, the example UF calculator 136 assigns the average unduplication factor to the specified (e.g., previously undefined) daypart-demographic group pairing. At block 822, the example UF calculator 136 determines whether there is another undefined unduplication factor. If, at block 822, the example UF calculator 136 determines that there is another undefined unduplication factor, then control returns to block 818 to calculate an average unduplicated factor. If, at block 822, the example UF calculated 136 determines that there is not another undefined unduplication factor, the example process 800 of FIG. 8 ends.

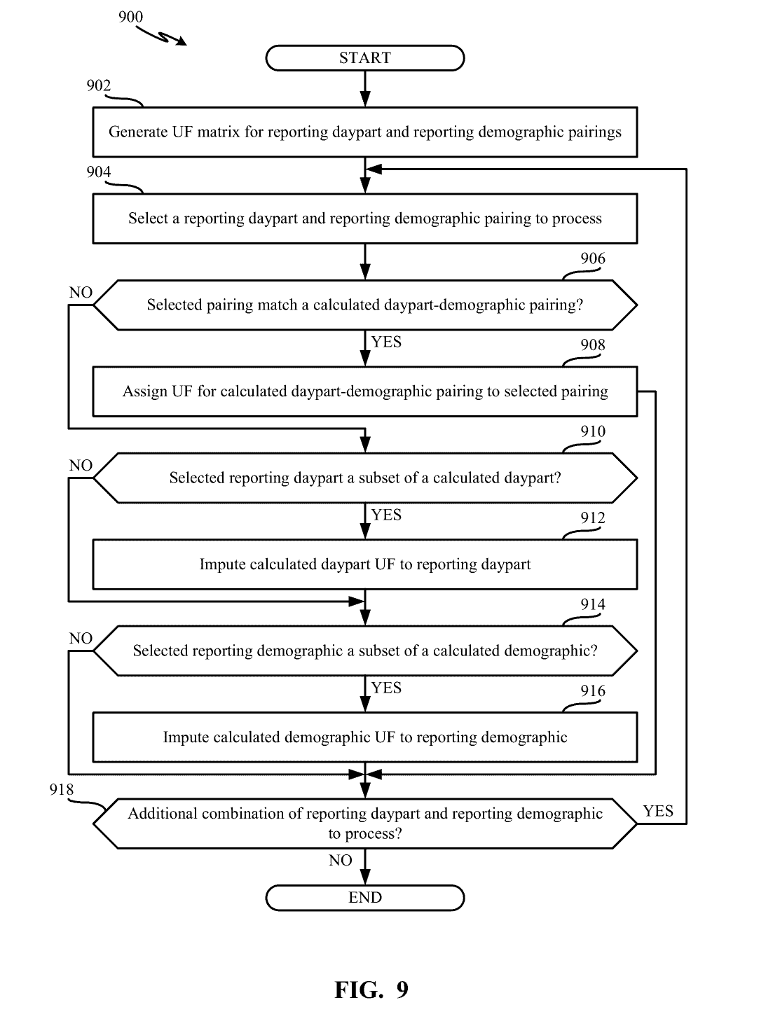

FIG. 9 is a flowchart representative of example machine-readable instructions 900 that may be executed by the example central facility 108 of FIG. 1 to populate a UF matrix with unduplication factors for daypart-demographic group pairings for reporting, for example, to the client 150. The example instructions 900 of FIG. 9 begin at block 902 when the example central facility 108 generates a UF matrix for daypart-demographic group pairings for reporting. For example, the example UF matrix generator 140 (FIG. 1) may generate a matrix based on pairings requested by the client 150. At block 904, the example UF matrix generator 140 selects a reporting daypart-reporting demographic group pairing to process. At block 906, the example UF matrix generator 140 determines whether the pairing for reporting matches a daypart-demographic group pairing used by the example UF calculator 136 to calculate a UF. If, at block 906, the example UF matrix generator 140 determines the pairing for reporting matches the pairing used for calculations, then, at block 908, the example UF matrix generator 140 assigns the calculated UF to the pairing for reporting. Control then proceeds to block 918 to determine whether there is another combination of reporting daypart and reporting demographic group pairing to process.

If, at block 906, the example UF matrix generator 140 determines that the pairing for reporting does not match a pairing used for calculations, then, at block 910, the example UF matrix generator 140 determines whether the selected reporting daypart is a subset of a daypart used in calculations. If, at block 910, the example UF matrix generator 140 determines that the selected reporting daypart is a subset of a daypart used in calculations, then, at block 912, the example UF matrix generator 140 imputes the calculated daypart UF to the reporting daypart.

If, at block 910, the example UF matrix generator 140 determines that the selected reporting daypart is not a subset of a daypart used in calculators, or, after the example UF matrix generator 140 imputes the calculated daypart UF at block 912, then, at block 914, the UF matrix generator 140 determines whether the selected reporting demographic group is a subset of demographic group used in calculations. If, at block 914, the example UF matrix generator 140 determines that the selected reporting demographic group is a subset of a demographic group used in calculations, then, at block 916, the UF matrix generator 140 imputes the calculated demographic group UF to the reporting demographic group.

At block 918, the example UF matrix generator 140 determines whether there is another combination of reporting daypart and reporting demographic group to process. If, at block 918, the example UF matrix generator 140 determines that there is another combination to process, then control returns to block 904 to select another reporting daypart and reporting demographic group pairing to process. If, at block 918, the example UF matrix generator 140 determines that there is not another combination to process, the example process 900 of FIG. 9 ends.

FIG. 10 is a flowchart representative of example machine-readable instructions 1000 that may be executed by the example central facility 108 of FIG. 1 to calculate a duplication corrected total Cume for a given daypart-demographic group pairing. The example instructions 1000 of FIG. 10 begin at block 1002 when the example central facility 108 selects a daypart-demographic group pairing to process. At block 1004, the example total Cume calculator 142 (FIG. 1) determines whether the OTA Cume for the selected pairing is greater than zero. If, at block 1004, the example total Cume calculator 142 determines that the OTA Cume for the selected OTA Cume is greater than zero, then, at block 1006, the example total Cume calculator 142 calculates an adjusted total digital Cume. For example, the total Cume calculator 142 may apply the unduplicated factor associated with the selected daypart-demographic group pairing to the total digital Cume for the selected pairing to calculate the adjusted total digital Cume. At block 1008, the example total Cume calculator 142 adds the adjusted total digital Cume to the OTA Cume to calculate the total Cume for the selected daypart-demographic group pairing. Control then proceeds to block 1012 to determine whether there is another daypart-demographic group pairing to process.

If, at block 1004, the example total Cume calculator 142 determines that the OTA Cume for the selected pairing is not greater than zero (e.g., is zero), then, at block 1010, uses the total digital Cume as the total Cume for the selected daypart-demographic pairing.

At block 1012, the example total Cume calculator 142 determines whether there is another daypart-demographic group pairing to process. If, at block 1012, the example total Cume calculator 142 determines that there is another pairing to process, control returns to block 1002 to selected another daypart-demographic group pairing to process. If, at block 1012, the example total Cume calculator 142 determines that there is not another pairing to process, the example process 1000 of FIG. 10 ends.

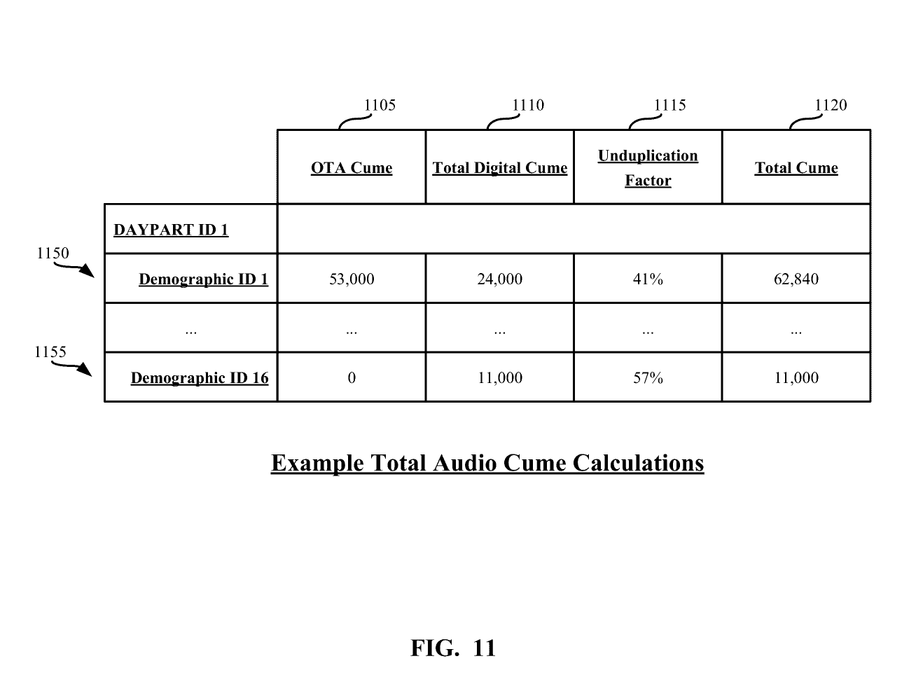

FIG. 11 illustrates an example total Cume calculation. In the illustrated example of FIG. 11, a total Cume 1100 for a broadcast station of interest is calculated based on OTA Cume 1105, total digital Cume 1110 and an unduplication factor 1115. The total Cume 1100 is calculated at the daypart-demographic group level. In the illustrated example, a first total Cume is calculated for a first daypart-demographic group pairing in first example row 1150, and a second total Cume is calculated for a second daypart-demographic group pairing in second example row 1155.

In the illustrated example of FIG. 11, the first example row 1150 identifies an OTA Cume of 53,000 and a total digital Cume of 24,000 for the first example daypart-demographic group pairing. The first example row 1150 also indicates that for the first example daypart-demographic group pairing, there is an overlap of 41% between the OTA audience count and the total digital audience count. To calculate the total Cume for the first example row 1150, the unduplication factor (e.g., 41%) is applied to the total digital Cume (e.g., 24,000) to calculate an adjusted total digital Cume (e.g., 41%*24,000=9,840). The adjusted total digital Cume (e.g., 9,840) is then added to the OTA Cume (e.g., 53,000) to calculate the total Cume (e.g., 53,000+9,840=62,840).

In the illustrated example of FIG. 11, the second example row 1155 identifies an OTA Cume of 0 and a total digital Cume of 11,000 for the second example daypart-demographic group pairing. The second example row 1155 also indicates that for the second example daypart-demographic group pairing, there is an overlap of 57% between the OTA audience count and the total digital audience count. However, because the OTA Cume for the second example daypart-demographic group pairing is zero, the unduplication factor (e.g., 57%) is not applied to the total digital Cume. That is, because the OTA Cume is zero, there is no overlap in the audience counts for the OTA station and the streaming station. The total Cume for the second example row 1155 is equal to the total digital Cume (e.g., 11,000).

FIG. 12 is a block diagram of an example processor platform 1200 capable of executing the instructions of FIGS. 5-9 and/or 10 to implement the central facility 108 of FIG. 1. The processor platform 1200 can be, for example, a server, a personal computer, or any other type of computing device.

The processor platform 1200 of the illustrated example includes a processor 1212. The processor 1212 of the illustrated example is hardware. For example, the processor 1212 can be implemented by one or more integrated circuits, logic circuits, microprocessors or controllers from any desired family or manufacturer.

The processor 1212 of the illustrated example includes a local memory 1213 (e.g., a cache). The processor 1212 of the illustrated example executes the instructions to implement the example data interface 110, the example panelist data manager 114, the example activity data manager 116, the example station data manager 118, the example daypart manager 124, the example demographics manager 126, the example listening data manager 128, the example digital Cume calculator 132, the example duplicate Cume calculator 134, the example UF calculator 136, the example UF matrix generator 140, and the example total Cume calculator 142.

The processor 1212 of the illustrated example is in communication with a main memory including a volatile memory 1214 and a non-volatile memory 1216 via a bus 1218. The volatile memory 1214 may be implemented by Synchronous Dynamic Random Access Memory (SDRAM), Dynamic Random Access Memory (DRAM), RAMBUS Dynamic Random Access Memory (RDRAM) and/or any other type of random access memory device. The non-volatile memory 1216 may be implemented by flash memory and/or any other desired type of memory device. Access to the main memory 1214, 1216 is controlled by a memory controller.

The processor platform 1200 of the illustrated example also includes an interface circuit 1220. The interface circuit 1220 may be implemented by any type of interface standard, such as an Ethernet interface, a universal serial bus (USB), and/or a PCI express interface.

In the illustrated example, one or more input devices 1222 are connected to the interface circuit 1220. The input device(s) 1222 permit(s) a user to enter data and commands into the processor 1212. The input device(s) can be implemented by, for example, an audio sensor, a microphone, a camera (still or video), a keyboard, a button, a mouse, a touchscreen, a track-pad, a trackball, isopoint and/or a voice recognition system.

One or more output devices 1224 are also connected to the interface circuit 1220 of the illustrated example. The output devices 1224 can be implemented, for example, by display devices (e.g., a light emitting diode (LED), an organic light emitting diode (OLED), a liquid crystal display, a cathode ray tube display (CRT), a touchscreen, a tactile output device, a printer and/or speakers). The interface circuit 1220 of the illustrated example, thus, typically includes a graphics driver card, a graphics driver chip or a graphics driver processor.

The interface circuit 1220 of the illustrated example also includes a communication device such as a transmitter, a receiver, a transceiver, a modem and/or network interface card to facilitate exchange of data with external machines (e.g., computing devices of any kind) via a network 1226 (e.g., an Ethernet connection, a digital subscriber line (DSL), a telephone line, coaxial cable, a cellular telephone system, etc.).

The processor platform 1200 of the illustrated example also includes one or more mass storage devices 1228 for storing software and/or data. Examples of such mass storage devices 1228 include floppy disk drives, hard drive disks, compact disk drives, Blu-ray disk drives, RAID systems, and digital versatile disk (DVD) drives. The example mass storage 1228 implements the example panelist audio measurement data database 112, the example listening data database 122 and the example filtered listening data database 130.

The coded instructions 1232 of FIGS. 5-9 and/or 11 may be stored in the mass storage device 1228, in the volatile memory 1214, in the non-volatile memory 1216, and/or on a removable tangible computer readable storage medium such as a CD or DVD.

From the foregoing, it will be appreciated that the above disclosed methods, apparatus and articles of manufacture enable duplication correction for broadcast station audience measurement data. For example, disclosed examples include using audience measurement data collected from panelists to calculate an unduplication factor. In some examples, the unduplication factor is calculated at a daypart-demographic group level. The calculated unduplication factor may then be used to remove duplicated audience counts for OTA stations and streaming stations.

Although certain example methods, apparatus and articles of manufacture have been disclosed herein, the scope of coverage of this patent is not limited thereto. On the contrary, this patent covers all methods, apparatus and articles of manufacture fairly falling within the scope of the claims of this patent.

What is claimed is:

1. A method to generate ratings information, the method comprising:
mapping, by executing an instruction with a processor, listening data to a daypart and a demographic group, the listening data generated based on collected audience measurement data;
calculating, by executing an instruction with the processor, a first audience measurement and a second audience measurement from the listening data for a plurality of daypart-demographic group pairings;
determining, by executing an instruction with the processor, an unduplication factor for a first daypart-demographic group pairing based on the first audience measurement and the second audience measurement; and
applying, by executing an instruction with the processor, the unduplication factor to an audience count associated with a streaming station to determine a cumulative audience measurement for the first daypart-demographic group pairing.

2. The method of claim 1, wherein the calculating of the first audience measurement includes summing contribution weights associated with a first set of panelists credited with listening to digital audio.

3. The method of claim 2, wherein the calculating of the second audience measurement includes summing contribution weights associated with a second set of panelists credited with listening to digital audio and over-the-air audio, the over-the-air audio distributed by a same distributor as the digital audio.

4. The method of claim 1, wherein the generating of the listening data includes:
identifying panelist information included in the audience measurement data associated with panelists who satisfy an activity threshold; and
merging audio exposure data of interest included in the audience measurement data with the panelist information, the audio exposure data being of interest when a duration of listening associated with the audio exposure data satisfies a duration threshold.

5. The method of claim 1, further including:
identifying a radio station included in an entry of the listening data;
determining if the radio station is a qualifying station based on a market code, a call letters code, a band code and station formation information; and
in response to determining that the radio station is not a qualifying station, removing the entry from the listening data.

6. The method of claim 1, wherein the mapping of the listening data to the daypart includes comparing a day identifier and a media day quarter-hour identifier associated with audio exposure data included in the audience measurement data to a first characteristic included in a list of daypart mappings.

7. The method of claim 1, wherein the mapping of the listening data to the demographic group includes comparing a gender identifier and an age identifier associated with panelist information included in the audience measurement data a second characteristic included in a list of demographic groups.

8. An apparatus to generate ratings information, the apparatus comprising:
a daypart manager to map listening data to a daypart, the listening data generated based on collected audience measurement data;
a demographics manager to map the listening data to a demographic group;
a first calculator to calculate a first audience measurement from the listening data for a plurality of daypart-demographic group pairings;
a second calculator to calculate a second audience measurement from the listening data for the plurality of daypart-demographic group pairings;
an unduplication factor calculator to determine an unduplication factor for a first daypart-demographic group pairing based on the first audience measurement and the second audience measurement; and
a third calculator to apply the unduplication factor to an audience count associated with a streaming station to determine a cumulative audience measurement for the first daypart-demographic group pairing.

9. The apparatus of claim 8, wherein the first calculator is to calculate the first audience measurement by summing contribution weights associated with a first set of panelists credited with listening to digital audio.

10. The apparatus of claim 9, wherein the second calculator is to calculate the second audience measurement by summing contribution weights associated with a second set of panelists credited with listening to digital audio and over-the-air audio, the over-the-air audio being distributed by a same distributor as the digital audio.

11. The apparatus of claim 8, further including:
a first data manager to identify panelist information included in the audience measurement data associated with panelists who satisfy an activity threshold; and
a second data manager to merge audio exposure data of interested included in the audience measurement data with the identified panelist information to generate the listening data, the audio exposure data being of interest when a duration of listening associated with the audio exposure data satisfies a duration threshold.

12. The apparatus of claim 8, further including a third data manager to:
identify a radio station included in an entry of the listening data;
determine if the radio station is a qualifying station based on a market code, a call letters code, a band code and station formation information; and
remove the entry from the listening data based on a determination that the radio station is not a qualifying station.

13. The apparatus of claim 8, wherein the daypart manager is to map the listening data to the daypart by comparing a day identifier and a media day quarter-hour identifier associated with audio exposure data included in the audience measurement data to a first characteristic included in a list of daypart mappings.

14. The apparatus of claim 8, wherein the demographics manager is to map the listening data to the demographic group by comparing a gender identifier and an age identifier associated with panelist information included in the audience measurement data a second characteristic included in a list of demographic groups.

15. A tangible machine-readable storage medium comprising instructions that, when executed, cause a processor to at least:
map listening data to a daypart, the listening data generated based on collected audience measurement data;
map the listening data to a demographic group;
calculate a first audience measurement from the listening data for a plurality of daypart-demographic group pairings;
calculate a second audience measurement from the listening data for the plurality of daypart-demographic group pairings;
determine an unduplication factor for a first daypart-demographic group pairing based on the first audience measurement and the second audience measurement; and
apply the unduplication factor to an audience count associated with a streaming station to determine a cumulative audience measurement for the first daypart-demographic group pairing.

16. The tangible machine-readable storage medium as defined in claim 15, wherein the instructions are to further cause the processor to calculate the first audience measurement by summing contribution weights associated with a first set of panelists credited with listening to digital audio.

17. The tangible machine-readable storage medium as defined in claim 16, wherein the instructions are to further cause the processor to calculate the second audience measurement by summing contribution weights associated with a second set of panelists credited with listening to digital audio and over-the-air audio, the over-the-air audio being distributed by a same distributor as the digital audio.

18. The tangible machine-readable storage medium as defined in claim 15, wherein the instructions are to further cause the processor to:
identify panelist information included in the audience measurement data associated with panelists who satisfy an activity threshold; and
merge audio exposure data of interested included in the audience measurement data with the identified panelist information to generate the listening data, the audio exposure data being of interest when a duration of listening associated with the audio exposure data satisfies a duration threshold.

19. The tangible machine-readable storage medium as defined in claim 15, wherein the instructions are to further cause the processor to:
identify a radio station included in an entry of the listening data;
determine if the radio station is a qualifying station based on a market code, a call letters code, a band code and station formation information; and
remove the entry from the listening data based on a determination that the radio station is not a qualifying station.

20. The tangible machine-readable storage medium as defined in claim 15, wherein the instructions are to further cause the processor to:
map the listening data to the daypart by comparing a day identifier and a media day quarter-hour identifier associated with audio exposure data included in the audience measurement data to a first characteristic included in a list of daypart mappings; and
map the listening data to the demographic group by comparing a gender identifier and an age identifier associated with panelist information included in the audience measurement data a second characteristic included in a list of demographic groups.
